(19) United States
(12) Patent Application Publication
(10) Pub. No.: US 2003/0183693 A1
(43) Pub. Date: Oct. 2, 2003

(54) Code reader

(76) Inventor: Atsutoshi Okamoto, Aichi (JP)

Correspondence Address: WENDEROTH, LIND & PONACK, L.L.P., 2033 K STREET N. W., SUITE 800, WASHINGTON, DC, 20006-1021, US

(21) Appl. No.: 10/397,287

(22) Filed: Mar. 27, 2003

Related U.S. Application Data
(63) Continuation of application No. 10/194,235, filed on Jul. 15, 2002, now abandoned.
Application No. 10/194,235 is a continuation of application No. 09/725,320, filed on Nov. 29, 2000, now abandoned.
Application No. 09/725,320 is a continuation of application No. 09/300,843, filed on Apr. 28, 1999, now abandoned.

(51) Int. Cl. G06K 7/10

(52) U.S. Cl. 235/462.43

(57) ABSTRACT

The present invention provides a code reader for reading a code marked on a material which tends to prevent diffused reflection, wherein a light source mounted in a reading case illuminates a code, a reflected light from which is read by a camera through an incident light diaphragm mechanism and a lens characterized in that an illumination light of said light source can be made to illuminate the code by means of at least one of a surface of said diaphragm mechanism and an inner surface of said reading case which allow diffused reflection, and that a normal line to a plain at a reading opening is formed such that the normal line is inclined to an optical axis of the camera.

### FIELD OF THE INVENTION

The present invention relates to a code (one-dimensional barcode, two-dimensional code) reader, particularly to a code reader for reading a code marked on a material which tends to prevent diffused reflection such as a transparent sheet of wrapping paper or a material with specular surface etc.

### PRIOR ART

Various kinds of goods are marked with codes (one-dimensional codes (bar codes), two-dimensional codes) which are read by means of a known code reader as shown in FIG. 4 for carrying out inventory control of the goods. In the code reader 30, a light source 31 directly illuminates a code 32, a reflected light from which is received by a camera (CCD photosensor etc.) 35 through an incident light diaphragm mechanism 33 and a lens 34 for carrying out decoding of coded information.

### PROBLEMS THAT THE INVENTIONS IS TO SOLVE

The above described conventional reader can read a code printed on a material such as a sheet of paper which causes diffused reflection. However, it is difficult for the code reader to read a code marked on a sheet of transparent wrapping paper which tends to prevent diffused reflection because it causes halation. Moreover, a one-dimensional or a two-dimensional code marked on a specular material such as a material of a medical instrument, a semiconductor wafer or a metallic instrument (specular code) makes it difficult to read the code with the conventional reader because of causing specular reflection. Accordingly, it is an object of the present invention to provide a code reader which can read information provided by both of a code marked on a material such as a sheet of paper that causes diffused reflection and a specular code.

### SUMMARY OF THE INVENTION

The present invention provides a code reader which is a reader wherein a light source mounted in a reading case illuminates a code, a reflected light from which is read by a camera through a lens. An illumination light of the light source can be made to illuminate the code by means of at least one of a surface of the diaphragm mechanism and an inner surface of the reading case which allow diffused reflection, and a normal line to a reading opening plane is formed such that the normal line is inclined to an optical axis of the camera. The code reader can indirectly illuminate the code and the normal line to the reading opening plane is formed such that the normal line is inclined to the optical axis of the camera. This can prevent an image of an aperture of the incident light diaphragm mechanism from being picked up by the camera and enables information reading of any of the specular code in addition to the code causing no diffused reflection.

Furthermore, the present invention provides a code reader which is a reader wherein a light source mounted in a reading case illuminates a code, a reflected light from which is read by a camera through a lens with an incident light diaphragm mechanism. A semi-transparent mirror plate is provided between the lens and the reading opening plane such that the mirror plate is inclined and the light source is provided as a plane light emitter, which is mounted to direct toward the semi-transparent mirror plate so that the plane light emitter can illuminate the semi-transparent mirror plate. This makes it possible to read information of any code including a specular code marked on a material causing specular reflection through the semi-transparent mirror plate. Regarding to the code reader above-identified, the present invention provides a code reader which is a reader wherein a light absorbing plate is mounted at an opposite position to the plane light emitter with respect to the semi-transparent mirror plate. The light absorbing plate can eliminate influence of the reflected light to well provide information reading of the specular code.

### BRIEF DESCRIPTION OF THE DRAWINGS

FIG. 1 is a cross sectional view of the main part showing the concept of the code reader according to the first embodiment.

FIG. 2 is a diagram illustrating function of the code reader.

FIG. 3 is a cross sectional view of the main part showing the concept of the code reader according to the second embodiment.

FIG. 4 is a cross sectional view of the main part showing the concept of a conventional code reader.

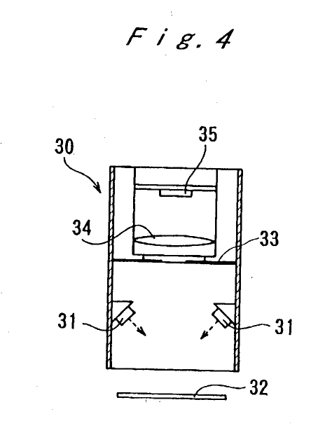

### DETAILED DESCRIPTION OF THE INVENTION

The code reader according to the present invention can read information of not only a code marked on a sheet of paper but also a specular code with such a simple design as to form a reading opening plane inclined to an optical axis of a camera. In addition, the code reader according to the present invention can read information of not only the code marked on a sheet of paper but also the specular code by reducing an amount of light incident on the camera by means of the semi-transparent mirror plate.

Based on following detailed embodiments, features and unexpected superior effects of the present invention are described.

(First Embodiment)

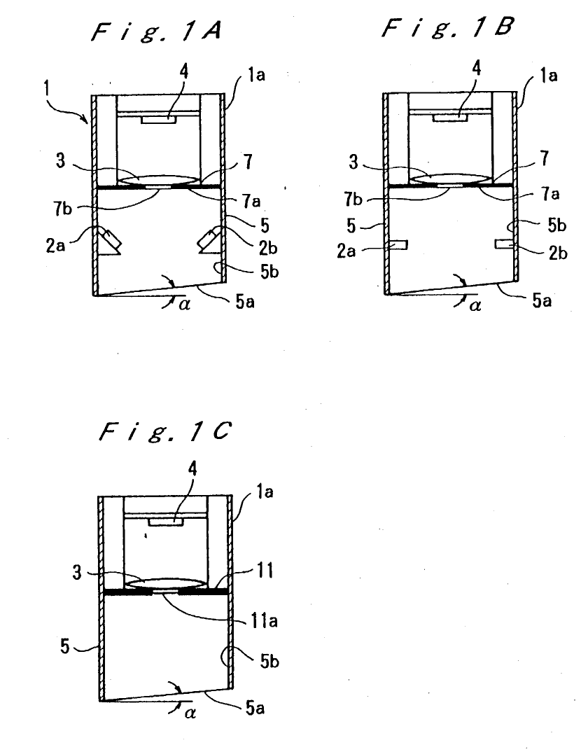

The embodiment is a code reader which can provide reading of not only a code (one-dimensional code (bar code), two-dimensional code) marked on a material causing diffused reflection but also a specular code (one-dimensional code or two-dimensional code marked on a specular material causing specular reflection). FIG. 1A is a cross sectional view of the main part showing a concept of a code reader 1. A case 1a and a reading case 5 provided as an extension thereof are integrally formed, with a camera (CCD photosensor, image pick-up tube etc.) 4 and a lens 3 disposed within the case 1a. On the side of a reading opening plane 5a of the lens 3, an incident light diaphragm mechanism (a slit) 7 having an aperture 7b formed therein is provided such that the readable range thereof corresponds to the reading opening plane 5a. It is desirable that the lens 3 is disposed in close proximity to the incident light diaphragm mechanism 7 so as to eliminate influence of the image of the aperture 7b.

Both of a surface 7a of the incident light diaphragm mechanism 7 except the aperture 7b, and the inner surface 5b of the reading case 5 are painted in bright color such as white, with a matte coating or a coating including fluorescent dye. Inside the reading case 5 at the end of the case, a light source 2 (2a, 2b) is mounted for emitting light toward the surface 7a of the incident light diaphragm mechanism 7 and the inner surface 5b of the reading case 5. Thus, the reading opening plane 5a is indirectly illuminated by the light from the light source 2 reflected by the surface 7a of the incident light diaphragm mechanism 7 and the inner surface 5b of the reading case 5 so that the code 32 can be lightened. The light source 2 is constituted in a bar-shape with light source elements such as a plurality of LED chips arranged in line. It is necessary for the code reader only that it is constituted so that the code 32 is not directly illuminated by the light source 2a, 2b. Thus, at least one of the surface 7a of the diaphragm mechanism and the inner surface 5b of the reading case 5 is enough to be made to allow diffused reflection for illuminating the reading opening plane 5a. The normal line to the reading opening plane 5a is formed such that the normal line is inclined (by an angle α) to the optical axis of the camera 4. It is preferable for the angle of inclination α to be 2-3°. It is more desirable for the shape of the aperture 7b to be rectangular than be circular because more amount of incident light can be obtained even the angle of inclination α is small.

FIG. 1B shows another code reader with the difference from that shown in FIG. 1A being in that the light source 2a, 2b emits light perpendicularly to the surface 7a of the incident light diaphragm mechanism 7.

Nevertheless, the code reader illuminates the code similarly to that in FIG. 1.

FIG. 1C shows further another code reader with the difference from that shown in FIG. 1A being in that a plane light emitter 11 that emits diffused light is mounted on the reading opening plane 5a side adjacent to the lens 3 with an aperture 11a opened at the center of the plane light emitter 11 and illuminates the reading opening plane 5a. That is, the difference is in that a plane light emitter 11 is mounted instead of the light sources 2, and the code is directly illuminated by the plane light emitter 11. The plane light emitter 11 is constituted so that it can illuminate the reading opening plane 5a with diffused light obtained by making use of electroluminescence, by illuminating liquid crystal with light provided on the backlight thereof, or by transmitting light emitted from an LED through a ground glass.

Each of the code readers constituted as is described above will be explained next with respect to the inclined shape of the reading opening plane 5a, in particular, to information reading of the specular code (one-dimensional code, two-dimensional code).

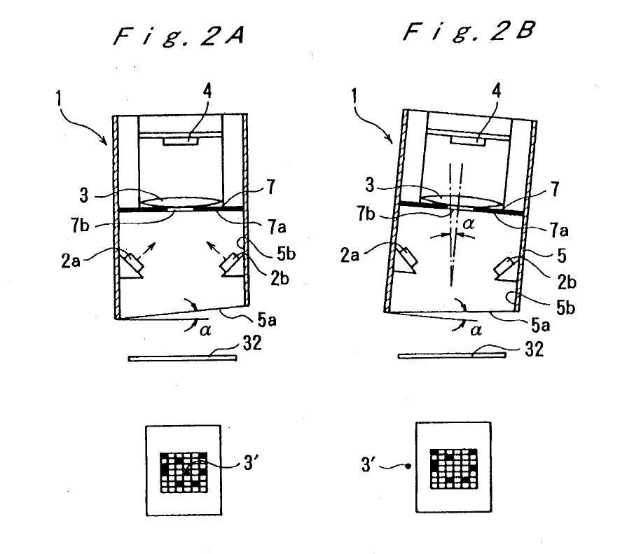

(a) Each of the code readers (FIGS. 1A, 1B, 1C) is provided with the reading opening plane 5a formed such that it is inclined to the optical axis of the camera 4. First, however, explanation is made about the case where the normal line to the reading opening plane 5a is formed horizontally to the optical axis of the camera (sensor etc.) 4 in the code readers (FIGS. 1A, 1B, 1C). By attaching the horizontal reading opening plane 5a to the code 32 marked on a material such as paper which causes no specular reflection, the code 32 is indirectly illuminated by the light source 2a, 2b to provide a lens image 3′ due to the aperture 7b (or aperture 11a) of the incident light diaphragm mechanism to be picked up by the camera 4. The lens image 3′, however, is low to the extent that it does not affect decoding of the code, and it is made possible to read information of the specular code. For the specular code (code causing specular reflection), however, influence of the lens image 3′ (black image) due to the aperture 7b (or aperture 11a) affects to cause misreading of information of the specular code by determining “white” as “black” (FIG. 2A).

(b) Accordingly, in order to prevent the lens image 3′ due to the aperture 7b (or aperture 11a) from affecting the specular code, the normal line to the reading opening plane 5a is formed such that the normal line is inclined (by an angle of inclination α) to the optical axis of the camera 4. This makes the lens image 3′, which is due to the aperture 7b (or aperture 11a) and is picked up by the camera 4, projected at a position where the image 3′ does not affect the image of the specular code so that the information of the specular code can be read correctly without any influence (FIG. 2B). As is described above, the code readers shown in FIGS. 1A, 1B, 1C) enable the reading of the specular code, but it is apparent that they can also read the code marked on a material such as a sheet of paper that causes diffused reflection.

(The Second Embodiment)

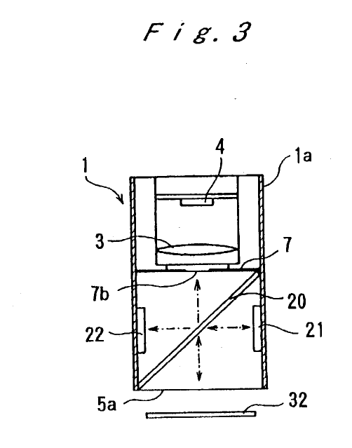

This embodiment is constituted in another way for preventing the above described lens image 3′ due to the aperture 7b (or aperture 11b) from affecting the image of the specular code. FIG. 3 is a cross sectional view of the main part of the code reader 1 according to the embodiment. A camera (CCD photosensor, image pick-up tube etc.) 4 and a lens 3 are disposed within the case 1a. On a reading opening plane 5a side of the lens 3, an incident light diaphragm mechanism (a slit) 7, with an aperture 7b formed therein, is provided on an inner surface such that the readable range thereof corresponds to the reading opening plane 5a. The lens 3 does not affect the image of the aperture 7b and it is not necessary to dispose the lens 3 in close proximity to the incident light diaphragm mechanism 7. A semi-transparent mirror plate 20 is mounted such that it is inclined and closes the reading opening plane 5a for shutting the incident light diaphragm mechanism 7 so as to prevent the lens 3 from dust. The angle of inclination is desirably determined to be at 45° and the transmissivity is best provided at 50%. The semi-transparent mirror plate 20 is made by various methods, one of which is to deposit a vaporized metal such as silver on a transparent glass plate.

Inside the reading opening plane 5a, a plane light emitter 21 with a uniform density of amount of illumination light is mounted so that it can illuminate the semi-transparent mirror plate 20. The plane light emitter 21 is constituted so that it can illuminate the semi-transparent mirror plate 20 with diffused light obtained by making use of electroluminescence, by illuminating liquid crystal with light provided on the backside thereof, or by transmitting light emitted from an LED through a ground glass. The surface of the plane light emitter 21 is formed to allow diffused reflection. It is preferable to mount a light absorbing plate 22 at an opposite position to the plane light emitter 21 with respect to the semi-transparent mirror plate 20, because the light absorbing plate 22 absorbs the light transmitted through the semi-transparent mirror plate 20 to prevent an influence due to the reflected light, but this is not necessarily required.

Next, the function of thus constituted code reader will be explained. The light from the plane light emitter 21 is incident on the semi-transparent mirror plate 20. Half of the amount of the incident light is reflected to illuminate the specular code and the other half is absorbed by the light absorbing plate 22 such that the influence of the reflected light is eliminated. The light illuminating the specular code 32 is reflected to become a light having the code information and is incident on the semi-transparent mirror plate 20. Half amount of the incident light reaches the camera 4 through the lens 3, while the rest amount of the light reaches the plane light emitter 21. As a result, the amount of the light reaching the camera 4 becomes below ¼ of that is emitted from the plane light emitter 21. The code reader can therefore read the specular code 32 with the lens image 3′ due to the aperture 7b (or aperture 11a) made to the extent that the lens image 3′ does not affect the information of the specular code. As described above, this code reader can read the specular code together with an obvious capability of reading the code marked on a material such as a sheet of paper that causes diffused reflection.

The reflected light with the information of the code reaches the plane light emitter 21 via the semi-transparnet mirror plate 20 without disturbing the uniformity in the density of amount of illuminating light of the plane light emitter 21 because the surface of the plane light emitter 21 is so formed as to cause diffused reflection. Hence, the surface of the light emitter plane 21 is preferably formed so as to cause diffused reflection.

Additional mounting of the light absorbing plate 22 is preferable in eliminating the influence of the reflected light.

1. A code reader wherein a light source mounted in a reading case illuminates a code, a reflected light from which is read by a camera through an incident light diaphragm mechanism and a lens characterized in that an illumination light of said light source can be made to illuminate the code by means of at least one of a surface of said diaphragm mechanism and an inner surface of said reading case which allow diffused reflection, and that a normal line to a plain at a reading opening is formed such that the normal line is inclined to an optical axis of the camera.

2. A code reader wherein a light source mounted in a reading case illuminates a code, a reflected light from which is read by a camera through an incident light diaphragm mechanism and a lens characterized in that a semi-transparent mirror plate is provided between said lens and said plain at said reading opening such that the semi-transparent mirror plate is inclined, said light source is provided as a plane light emitter, and the plane light emitter is mounted to direct toward said semi-transparent mirror plate so that the plane light emitter can illuminate the semi-transparent mirror plate.

3. A code reader as claimed in claim 2 wherein a light absorbing plate is mounted at an opposite position to the plane light emitter with respect to the semi-transparent mirror plate.
